(19) United States
(12) Patent Application Publication
(10) Pub. No.: US 2021/0163043 A1
(43) Pub. Date: Jun. 3, 2021

(54) VEHICLE AND METHOD OF CONTROLLING THE SAME

(71) Applicants: HYUNDAI MOTOR COMPANY, SEOUL (KR); KIA MOTORS CORPORATION, SEOUL (KR)

(72) Inventors: Sangyeob Lee, Seongnam-si (KR); Hong Gi Park, Seoul (KR); Ilhwan Kim, Hwaseong-si (KR); Donghyuk Kim, Hwaseong-si (KR); Kyung-joo Bang, Seoul (KR)

(21) Appl. No.: 16/917,002

(22) Filed: Jun. 30, 2020

(30) Foreign Application Priority Data
Dec. 2, 2019 (KR) 10-2019-0158439

(51) Int. Cl. B60W 60/00; B60W 50/16; B60W 40/09; B60W 40/06; B60W 10/20; B60W 10/18; B60W 10/04

(52) U.S. Cl. CPC B60W 60/0051; B60W 50/16; B60W 40/09; B60W 40/06; B60W 2050/146; B60W 10/18; B60W 10/04; B60W 60/001; B60W 10/20

(57) ABSTRACT

A vehicle includes a sensor configured to detect a travelling environment of the vehicle, an inputter configured to receive acceleration/deceleration information, steering information, or braking information during travel of the vehicle, and a controller configured to compare the information received by the inputter with preset information, determine whether a user is a novice driver based on a result of the comparison, and control at least one of a plurality of devices provided in the vehicle based on a result of the determination.

### CROSS REFERENCE TO RELATED APPLICATIONS

This application is based on and claims priority under 35 U.S.C. § 119 to Korean Patent Application No. 10-2019-0158439, filed on Dec. 2, 2019 in the Korean Intellectual Property Office, the disclosure of which is incorporated herein by reference.

### BACKGROUND

### 1. Field

The disclosed embodiment relates to a vehicle and a method of controlling the same, and more specifically, to a technique for determining whether a user is a novice driver and controlling a vehicle based on a result of the determination.

### 2. Description of the Related Art

As a method of providing driving guide information for a novice driver, a method of recognizing a driving situation of a vehicle, analyzing the recognition result and a user's travelling pattern, and outputting the analysis result to the user has been used.

However, the conventional technology requires analyzing a user's driving pattern and has difficulty in providing a driving guide to a novice driver whose a driving pattern has not been generated.

### SUMMARY

Therefore, it is an object of the disclosure to provide a vehicle capable of determining whether a user is a novice driver, and providing a novice driver with a travelling practice guide based on the determination result, and a method of controlling the same.

Additional aspects of the disclosure will be set forth in part in the description which follows and, in part, will be obvious from the description, or may be learned by practice of the disclosure.

It is an aspect of the disclosure to provide a vehicle including a sensor configured to detect a travelling environment of the vehicle, an inputter configured to receive acceleration/deceleration information, steering information, or braking information during travel of the vehicle, and a controller configured to compare the information received by the inputter with preset information, determine whether a user is a novice driver based on a result of the comparison, and control at least one of a driving device, a steering device, or a braking device provided in the vehicle based on a result of the determination.

The vehicle may further include a display on which a traveling route of the vehicle is displayed, wherein the controller may generate a practice travelling route and control the display to display the generated practice travelling route.

The controller may determine whether a frequent accident area or a construction section exists in the practice travelling route, and may end a driving practice mode when the frequent accident area or the construction section exists in the practice travelling route.

The controller may determine a degree of difficulty of the practice travelling route, and may control a result of the determination to be displayed on the display.

The controller may determine a type of a road being travelled by the vehicle, and may execute a practice travelling mode according to a city travelling practice mode, a parking practice mode, or a highway travelling practice mode based on a result of the determination.

The vehicle may further include a communicator configured to receive information related to a destination from a user terminal, wherein the controller may generate a practice travelling route to the destination, determine a type of a road included in the generated practice travelling route, and execute the practice travelling mode according to the city travelling practice mode, the parking practice mode, or the highway travelling practice mode based on a result of the determination.

The vehicle may further include an occupant detecting sensor configured to detect a number of occupants boarding the vehicle, wherein the controller may end the driving practice mode upon determining that the number of the occupants boarding the vehicle is two or more as a result of the detection by the sensor.

The controller may determine whether the user is a novice driver upon determining that a result of the detection by the sensor is a rainfall or snowfall situation and an off-state of a wiper.

The vehicle may further include a warner configured to warn the user through sound or vibration, wherein the controller may include the information received by the inputter with preset information, and control the warner upon determining that a result of the comparison is greater than or equal to a predetermined value.

The controller may allow the vehicle to perform a pilot travelling based on the received information.

It is another aspect of the disclosure to provide a method of controlling a vehicle, the method including detecting a travelling environment of the vehicle, receiving acceleration/deceleration information, steering information, or braking information during travel of the vehicle, and comparing the received information with preset information, determining whether a user is a novice driver based on a result of the comparison, and controlling at least one of a plurality of devices provided in the vehicle based on a result of the determination.

The method may further include displaying a traveling route of the vehicle, wherein the controlling may include generating a practice travelling route and controlling the generated practice travelling route to be displayed.

The controlling may include determining whether a frequent accident area or a construction section exists in the practice travelling route, and ending a driving practice mode when the frequent accident area or the construction section exists in the practice travelling route.

The controlling may include determining a degree of difficulty of the practice travelling route, and controlling a result of the determination to be displayed.

The controlling may include determining a type of a road being travelled by the vehicle, and executing a practice travelling mode according to a city travelling practice mode, a parking practice mode, or a highway travelling practice mode based on a result of the determination.

The method may further include receiving information related to a destination from a user terminal, wherein the controlling may include generating a practice travelling route to the destination, determining a type of a road included in the generated practice travelling route, and executing the practice travelling mode according to the city travelling practice mode, the parking practice mode, or the highway travelling practice mode based on a result of the determination.

The method may further include detecting a number of occupants boarding the vehicle, wherein the controlling may include ending the driving practice mode upon determining that the number of the occupants boarding the vehicle is two or more as a result of the detection.

The controlling may include determining whether the user is a novice driver upon determining that a result of the detection is a rainfall or snowfall situation and an off-state of a wiper.

The method may further include warning the user through sound or vibration, wherein the controlling may include comparing the received information with preset information, and warning upon determining that a result of the comparison is greater than or equal to a predetermined value.

The controlling may include allowing the vehicle to perform a pilot travel based on the received information.

### BRIEF DESCRIPTION OF THE FIGURES

These and/or other aspects of the disclosure will become apparent and more readily appreciated from the following description of the embodiments, taken in conjunction with the accompanying drawings of which:

FIG. 1 illustrates a vehicle according to an aspect of the disclosure;

FIG. 2 is a control block diagram illustrating a configuration of a vehicle according to an aspect of the disclosure;

FIG. 3 illustrates a process of determining whether a user is a novice driver by a controller according to an aspect of the disclosure;

FIG. 4 illustrates a process of executing a practice travelling mode by a controller according to an aspect of the disclosure;

FIG. 5 illustrates a process of providing a user with a practice travelling mode by a controller according to an aspect of the disclosure;

FIG. 6 illustrates a process of ending a practice travelling mode based on the number of occupants by a controller according to an aspect of the disclosure; and

FIG. 7 illustrates a process of controlling a warner to warn a user by a controller according to an aspect of the disclosure.

### DETAILED DESCRIPTION

Like numerals refer to like elements throughout the specification. Not all elements of embodiments of the present disclosure will be described, and description of what are commonly known in the art or what overlap each other in the embodiments will be omitted. The terms as used throughout the specification, such as “˜ part”, “˜ module”, “˜ member”, “˜ block”, etc., may be implemented in software and/or hardware, and a plurality of “˜ parts”, “˜ modules”, “˜ members”, or “˜ blocks” may be implemented in a single element, or a single “˜ part”, “˜ module”, “˜ member”, or “˜ block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and embodiments of the present disclosure will be described with reference to the accompanying drawings.

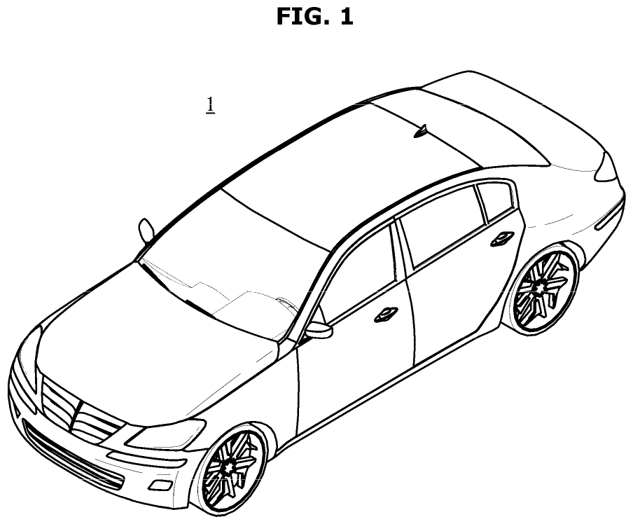

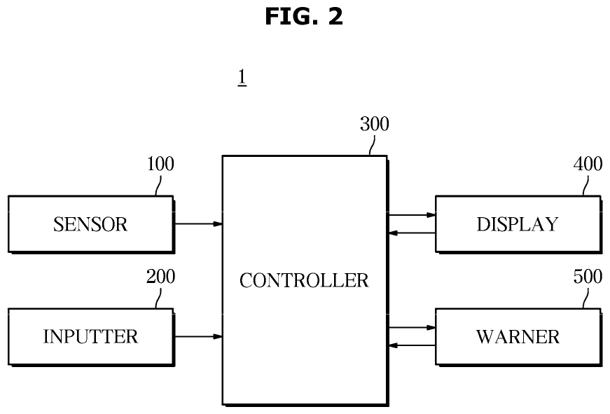

FIGS. 1 and 2 illustrate a vehicle 1 according to an aspect of the disclosure.

Referring to FIGS. 1 and 2, the vehicle 1 according to the disclosed aspect may include a sensor 100, an inputter 200, a controller 300, and a display 400, and a warner 500. Further, the vehicle 1 according to the disclosed embodiment may include a driving device, a braking device, a wiper, a headlight, or a turn signal. However, the configuration of the vehicle 1 is not limited thereto, and may further include a configuration that may affect travelling, braking, or controlling of the vehicle 1.

In detail, the sensor 100 according to the disclosed embodiment detects a surrounding environment of the vehicle 1. Here, the surrounding environment of the vehicle 1 may include surrounding vehicle information, surrounding weather information, or surrounding object information. However, the surrounding environment information of the vehicle 1 is not limited thereto, and may further include other factors that may affect the safety of the vehicle 1.

In addition, the sensor 100 may detect the number of occupants in the vehicle 1.

The sensor 100 may include a lidar sensor, a radar sensor, a speed sensor, a rain sensor, a camera sensor, a pressure sensor, or a temperature sensor. However, the sensor included in the sensor 100 is not limited thereto, and may further include other sensors capable of detecting the environment of the vehicle 1 or the interior of the vehicle 1.

The inputter 200 according to the disclosed embodiment receives information related to a driving practice mode. The inputter 200 may be linked with a user terminal (not shown), such as a navigation system or a smart phone. Also, the inputter 200 may include a human machine interface (HMI).

Here, the information related to the driving practice mode includes acceleration/deceleration information of the vehicle 1, steering range information of the vehicle 1, lane departure information of the vehicle, information related to a user's response to a change in weather conditions, or braking information of the vehicle 1 in response to presence/absence of a preceding vehicle. However, the information related to the driving practice is not limited thereto, and may include other information that may affect the travelling of the vehicle 1.

The inputter 200 may include hardware devices for a user's input, such as various buttons or switches, pedals, keyboards, mouse, trackballs, various levers, handles, or sticks.

In addition, the inputter 200 may include software devices for a user's input, such as a touch pad of a graphical user interface (GUI) or the like. The touch pad is implemented as a touch screen panel (TSP) to form a mutual layer structure with the display.

In addition, the user terminal may be implemented as a computer or a portable terminal that may access the vehicle 1 through a network. Here, the computer includes, for example, a laptop computer, a desktop computer, a tablet personal computer (PC), a slate PC, and the like, equipped with a web browser (WEB Browser), and the portable terminal is a wireless communication device with portability and mobility, and may include all types of handheld based wireless communication devices, such as a personal communication system (PCS), a global system for mobile communications (GSM), a personal digital cellular (PDC), a personal handy phone system (PHS), a personal digital assistant (PDA), an international mobile telecommunication (IMT)-2000, a code division multiple access (CDMA)-2000, a w-code division multiple access (W-CDMA), a wireless broadband internet (WiBro) terminal, a smart Phone, and the like; and wearable devices, such as a watch, a ring, a bracelet, an ankle bracelet, a necklace, glasses, a contact lens, or a head-mounted-device (HIVID), for example.

The controller 300 according to the disclosed embodiment compares information input to the inputter 200 with preset information, determines whether the user is a novice driver based on the comparison result, and control at least one of the plurality of devices provided in the vehicle 1 based on the determination result. The information input here may be acceleration/deceleration information, steering information, or braking information of the vehicle 1 that is input while the vehicle 1 is travelling.

In addition, the controller 300 may generate a practice traveling route to be suggested to the user, and may control the plurality of devices provided in the vehicle 1 such that the vehicle 1 performs a pilot travelling along the generated practice travelling route.

In detail, the plurality of devices provided in the vehicle 1 may include the driving device, the steering device, the braking device, the wiper, the headlight, or the turn signal. However, the configuration of the vehicle 1 is not limited thereto, and may further include a configuration that may affect travelling, braking, or controlling of the vehicle 1.

In addition, the controller 300 may determine destination information received from the user terminal to a communicator (not shown), and generate a travelling route of the vehicle 1 based on the determination result. In addition, the controller 300 analyzes the generated travelling route information and may suggest a city travelling practice mode, a parking practice mode, or a highway travelling practice mode to a user based on the analysis result.

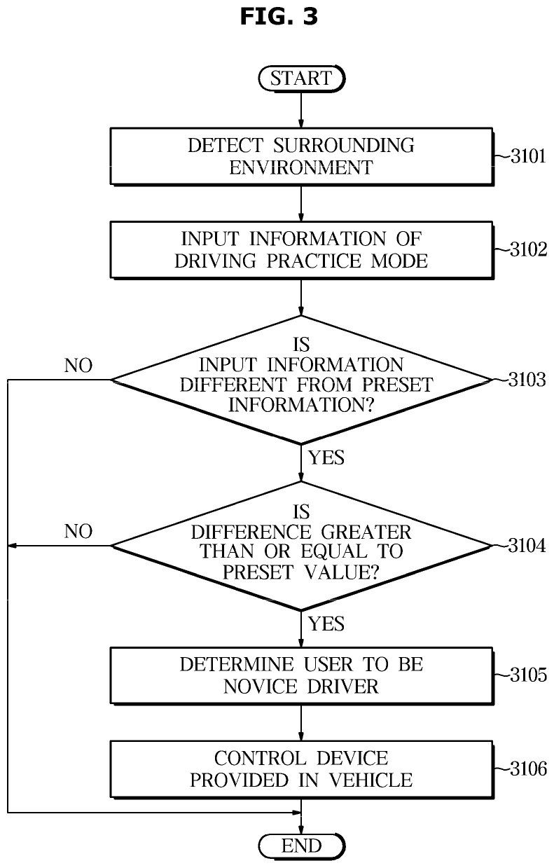

The process of the controller 300 controlling the plurality of devices provided in the vehicle 1 will be described below with reference to FIGS. 3 to 7.

Meanwhile, the controller 300 may include a communicator (not shown) to communicate with the sensor 100, the inputter 200, the display 400, the warner 500, or other devices provided in the vehicle 1.

The communicator (not shown) may include one or more components that enable communication with an external device, and may include at least one of a short-range communication module, a wired communication module, and a wireless communication module.

The short-range communication module may include various short-range communication modules that transmit and receive signals using a wireless communication network in a short range, such as a Bluetooth module, an infrared communication module, a radio frequency identification (RFID) communication module, a wireless local access network (WLAN) communication module, an NFC communication module, and a zigbee communication module.

The wired communication module may include not only various wired communication modules, such as a controller area network (CAN) communication module, a local area network (LAN) communication module, a wide area network (WAN) module, or a value added network (VAN) module, but also various cable communication modules, such as a universal serial bus (USB), a high definition multimedia interface (HDMI), a digital visual interface (DVI), a recommended standard 232 (RS-232), power line communication, or plain old telephone service (POTS).

The wireless communication module may include wireless communication modules supporting various wireless communication methods, such as a Wifi module, a wireless broadband module (Wibro) module, a global system for mobile communication (GSM) module, a code division multiple access (CDMA) module, a wideband code division multiple access (WCDMA) module, a universal mobile telecommunications system (UMTS) module, a time division multiple access (TDMA) module, a long term evolution (LTE) module, and the like.

The wireless communication module may include a wireless communication interface including an antenna and a transmitter for transmitting signals. In addition, the wireless communication module may further include a signal converting module for converting a digital control signal output from the controller 300 through the wireless communication interface into an analog type wireless signal under the control of the controller.

The wireless communication module may include a wireless communication interface including an antenna and a receiver for receiving signals. In addition, the wireless communication module may further include a signal converting module for demodulating an analog type wireless signal received through the wireless communication interface into a digital control signal.

In addition, the controller 300 may include a memory (not shown) for storing data regarding an algorithm for controlling the operations of the components of the vehicle 1 or a program that represents the algorithm, and a processor (not shown) that performs the above described operations using the data stored in the memory. In this case, the memory and the processor may be implemented as separate chips. Alternatively, the memory and the processor may be implemented as a single chip.

The display 400 according to the disclosed embodiment displays a determination result or a control result of the controller 300.

In detail, the display 400 may display a practice travelling route generated by the controller 300 and suggest the practice travelling route to the user. In addition, the display 400 may notify the user of the practice travelling route determined by the controller 300. The display 400 may be a head-up display (HUD) provided in the vehicle 1.

In addition, the display 400 may include a cathode ray tube (CRT), a digital light processing (DLP) panel, a plasma display panel, a liquid crystal display (LCD) panel, an electro luminescence (EL) panel, an electrophoretic display (EPD) panel, an electrochromic display (ECD) panel, a light emitting diode (LED) panel or an organic light emitting diode (OLED) panel, but is not limited thereto.

When the display 400 is provided as a touch screen panel (TSP) having a layer structure with a touch pad, the display 400 may be used as the inputter 200.

The warner 500 according to the disclosed embodiment generates sound or vibration through a device provided in the vehicle 1 and warns the user.

According to the disclosed embodiment, when a user is determined to be a novice driver, and the behavior of the vehicle 1 is determined to be different from preset traveling information by a predetermined reference value or greater, the warner 500 may generate sound through an audio device provided in the vehicle 1.

Further, according to the disclosed embodiment, the warner 500 may be provided in a steering wheel provided in the vehicle 1 and may warn the user by generating vibration on the steering wheel.

At least one component may be added or omitted according to the performances of the components of the vehicle 1 shown in FIG. 2. In addition, the mutual positions of the components may be changed to correspond to the performance or structure of the system.

Meanwhile, the components shown in FIG. 2 may refer to a software component and/or a hardware component, such as a Field Programmable Gate Array (FPGA) and an Application Specific Integrated Circuit (ASIC).

Hereinafter, a process of controlling the plurality of devices provided in the vehicle 1 by the controller 300 will be described in detail.

FIG. 3 illustrates a process of determining whether a user is a novice driver by the controller 300 according to an aspect of the disclosure.

Referring to FIG. 3, the sensor 100 according to the disclosed embodiment detects the environment around the vehicle 1 and transmits the detection result to the controller 300 at 3101).

In addition, the inputter 200 receives driving practice mode information of the vehicle 1 during travel at 3102.

In detail, the driving practice mode information may include acceleration/deceleration input information of the vehicle 1, steering input information of the vehicle 1, user response input information in response to a change in weather conditions, or braking input information.

Upon determining that there is a difference between the input information and preset information, the controller 300 may convert the input information into a score and compare the score with a preset value at 3103 and 3104. Here, the preset value may represent a speed specified by a law on a road travelled on by the vehicle 1, or an average braking value or steering value of other vehicles on the road.

However, upon determining that there is no difference between the input information and the preset information, or the difference between the input information and the preset information is less than the preset value, the controller 300 ends the process of determining whether the user is a novice driver.

When determined as a result of comparing the input information with the preset information that the difference between the input information and the preset information is greater than or equal to the preset value, the controller 300 determines the user as a novice driver at 3105.

For example, the controller 300 may calculate a score of acceleration/deceleration input on the basis of a driving speed range of the vehicle 1 based on speed information of the vehicle 1. In detail, the controller 300, upon determining that the vehicle 1 is outside a preset speed range of the vehicle 1 when 60 seconds have elapsed since the vehicle 1 is stopped or is driven, calculates an acceleration/deceleration input score as −1 point for each second.

Here, the preset speed range of the vehicle 1 may be 70% of the speed limit of the road travelled on by the vehicle 1. For example, in the road where the speed limit is set to a minimum speed of 30 km/h and a maximum speed of 100 km/h, the preset speed range of the vehicle 1 may be set to a minimum speed of 21 km/h and a maximum speed of 70 km/h.

In addition, the controller 300 may determine steering information based on lane information input from the sensor 100.

For example, the controller 300 may calculate the number of lane departures/mileage without an input of a lane change switch and calculate a steering score as −1 point for each time of lane change.

In addition, the controller 300 may check the current rain/snow condition through a rain sensor, and calculate a score as −1 point when the wiper is not operated in the rain or snow condition.

In addition, the controller 300 may determine whether a preceding vehicle is present, and upon determining that inappropriate braking has occurred, calculate a braking score as −1 point for each second.

In addition, when a final score is determined to be −60 or less per minute, the controller 300 may recognize the user as a novice driver.

However, the above described process of comparing a preset value with driving practice mode information and determining a user as a novice driver is only an example, and a criterion for determining a user as a novice driver may vary according to a user definition.

When a user is determined to be a novice driver, the controller 300 controls the plurality of devices provided in the vehicle 1 at 3106.

As described above, the plurality of devices provided in the vehicle 1 may include the travelling device, the braking device, the wiper, the headlight, or the turn signal. However, the configuration of the vehicle 1 is not limited thereto, and may further include a configuration that may affect travelling, braking, or control of the vehicle 1.

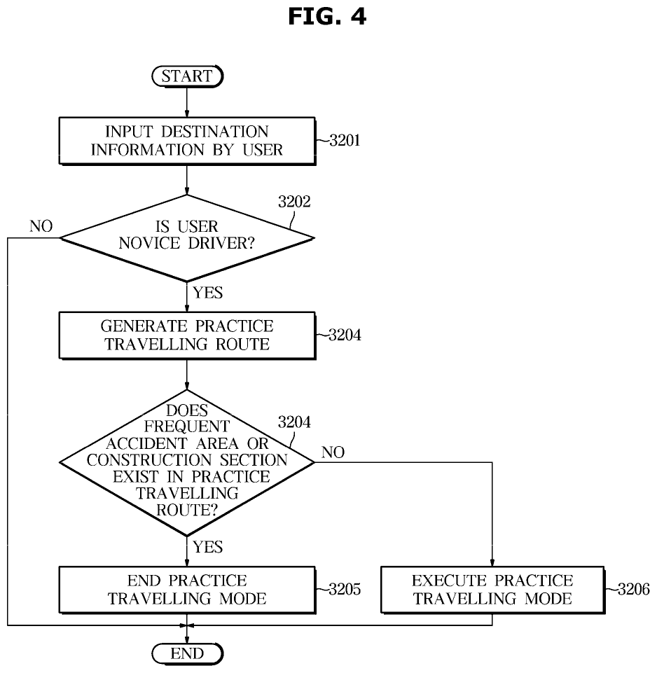

FIG. 4 illustrates a process of executing a practice travelling mode by the controller 300 according to an aspect of the disclosure.

Referring to FIG. 4, the user terminal may receive destination information from a user and transmit the input destination information to the controller 300 through the communicator (not shown) at 3201.

The destination information may include the address of the destination, the time taken to travel from the current location of the vehicle 1 to the destination, or route information from the current location to the destination.

In addition, upon determining that the user is a novice driver, the controller 300 generates a practice travelling route based on the input destination information at 3202 and 3203. However, upon determining that the user is not a novice driver, the controller 300 does not generate a practice travelling route and ends the control process.

In detail, the practice travelling route may be generated in a city travelling practice mode or a highway mode based on a route to the destination. In addition, when the user needs to park at the end of the practice travelling route, the practice travelling route may further include a route generated in a parking practice mode.

Here, the practice travelling route generated in the city travelling practice mode includes information about a lane change guide, a left and right turn appropriate speed guide, a braking timing and braking amount guide according to a state of a preceding vehicle, an unprotected left turn guide, a roundabout guide, a U-turn mode guide, and a cut-in (lane change) mode guide, a night travelling mode guide, or a rain/snow travelling mode guide.

In detail, the lane change guide, at a time of a lane change, may monitor a lane to which the vehicle is planning to transition using information of a rear side radar, and when a vehicle is not in the corresponding route, indicate the driver that a lane change is performable. In addition, the lane change guide may suggest a speed of the vehicle 1 such that the vehicle 1 changes lanes at a proper speed (+/−20% of the speed limit (navigation input information) of the road). In addition, upon determining that the driver's steering is insufficient or excessive during a lane change, the controller 300 may compensate for a torque through a steering controller. In addition, upon determining that a longitudinal speed differs from a proper speed at a time of lane change, the lane change guide may correct the speed through a longitudinal controller (braking and engine). In addition, the lane change guide may give a feedback on the results of the control after the driver changes the lanes (e.g., “Excellent”, “Speed was not enough, so, for the next time of lane change, speed up more”, “it is dangerous to suddenly turn the steering wheel and cut in).

In addition, the U-turn mode guide may advise a U-turn timing and a steering control amount in a U-turn lane when the vehicle 1 requires a U-turn.

In addition, the night travelling mode guide may provide the driver with the position of a proper headlamp switch and precautions when the vehicle 1 is driven at night.

In addition, the rain/snow travelling mode guide may provide the vehicle 1 with guidance as to a proper speed and wiper operation when it is raining or snowing.

In addition, the braking timing and braking amount guide according to the state of the preceding vehicle may inform the driver of the need for a braking control, upon determining that an area of traffic caught in a red light exists while driving the vehicle 1 or upon determining that nearby vehicles in the route are slowing down.

In addition, the braking timing and braking amount guide according to the state of the preceding vehicle may inform the driver of a braking timing, determines whether a braking power is insufficient, and upon determining that the braking power is insufficient, assist in the braking control.

In addition, the braking timing and braking amount guide according to the state of the preceding vehicle may provide a feedback on the result of the driver's driving.

In addition, the unprotected left turn guide determines whether a nearby vehicle is in the traveling route based on information related to the nearby vehicles input from the sensor, and induces a unprotected left turn of the vehicle 1 based on the determination result and traffic light information so that the driver may easily perform driving.

In addition, the practice travelling route generated in the highway mode may include information about a highway travel appropriate speed guide, a braking timing and braking amount guide, a highway lane change guide, a high-pass passing guide, a toll gate guide, or a congestion situation driving guide.

In detail, the highway travelling appropriate speed guide provides guidance as to a method of maintaining the speed of the vehicle 1 on the highway and advising the driver about frequent uses of the brake and the lane keeping. When the vehicle 1 is deflected to one side with respect to the lane, the highway travelling appropriate speed guide may advise the driver to drive along the center of the lane.

In addition, the highway lane change guide may provide the driver with advice, such as lighting a turn signal and appropriate speed/steering angle when changing lanes in a high-speed area, and advise the driver to change lanes.

In addition, the high-pass/toll gate passing guide may advise the driver to drive at an appropriate speed and travel along a center of a lane when the vehicle 1 passes through a high-pass or toll gate.

In addition, the congestion situation driving guide may advise the driver about a proper distance between the vehicle 1 and the preceding vehicle in traffic congestion and a safe driving for preventing driver drowsiness.

The practice travelling route generated in the parking practice mode may include perpendicular/parallel parking practice mode information, parking availability determination guide, or exit guide information.

In detail, when a driver desires to practice parking, the driver may request a parking practice mode through a practice travelling mode setting system. Upon determining an existence of the request for a parking practice mode, the controller 300 uses a Smart Parking Assist System and determines whether parking is performable. In addition, the controller 300 may control the vehicle 1 to demonstrate a parking by automatic parking.

In addition, in the parking practice mode, the controller 300 may provide the driver with advice on a steering method and a speed tip for keeping a low speed, and control the plurality of devices provided in the vehicle 1 such that the driver drives the vehicle by him/herself.

In addition, the exit guide may provide guidance as to the direction of exit when the driver desires to leave the parked space and may advise about steering and gear shifting (D position, R positon).

In addition, in the parking practice mode, the controller 300 may determine whether parking is performable. In detail, when the vehicle 1 moves in a parking lot, the controller 300 may determine whether parking is performable through an ultrasonic sensor. In addition, upon determining that the vehicle 1 attempts a parking in a space in which parking is not performable, the controller 300 notifies the driver that parking is not performable and provides a parking guide (a parking direction) to a place where parking is performable.

However, the information included in the practice travelling route generated in the city travelling practice mode, the highway mode, or the parking practice mode is not limited to the above, and may further include other information that may affect the travelling of the vehicle 1.

The controller 300 determines whether a frequent accident area or a construction section exists in the generated practice travelling route at 3204.

In detail, upon determining that the generated practice travelling route includes a frequent accident area or a construction section, the controller 300 ends the practice travelling mode of the vehicle 1 at 3205. However, upon determining that a frequent accident area or a construction section does not exist in the generated practice travelling route, the controller 300 executes the practice travelling mode of the vehicle 1 at 3206.

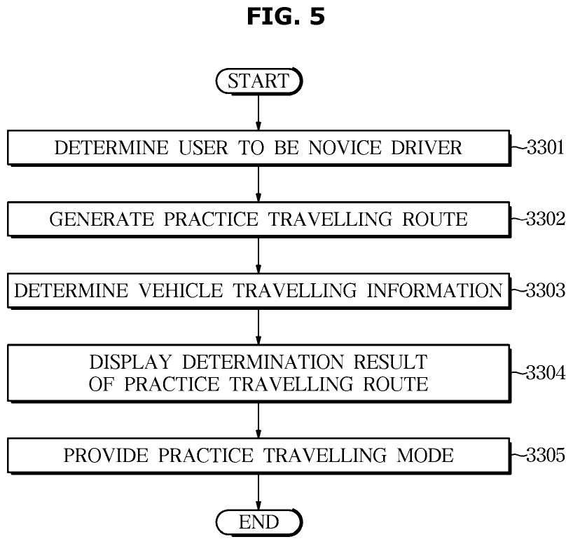

FIG. 5 illustrates a process of providing a user with a practice travelling mode by the controller 300 according to an aspect of the disclosure.

When a user is determined to be a novice driver through the above-described process, the controller 300 generates a practice travelling route at 3301 and 3302.

In addition, the controller 300 may determine traveling information of the vehicle 1 based on previously input destination information or the generated practice travelling route at 3303).

The controller 300 may determine the practice travelling route based on the generated practice travelling route or the determined travelling information of the vehicle 1, and control the display 400 to display the determination result at 3304.

In detail, the controller 300 determines the degree of difficulty of the practice travelling route, the existence of a frequent accident area, a construction section, or a congestion section in the practice travelling route, the average speed of other vehicles in the practice travelling route, or the mode of the practice travelling route, and controls the display 400 to display the determination result on the display 400.

In addition, the controller 300 may suggest to the user the determined practice travelling route and an opinion on the practice travelling route based on user information.

The controller 300 may display the determined practice travelling route to the user, and when the user determines to travel the generated practice travelling route, provide the user with the practice travelling mode at 3305.

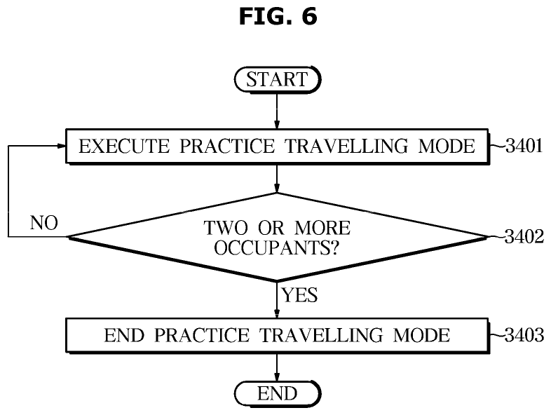

FIG. 6 illustrates a process of ending a practice travelling mode based on the number of occupants by the controller 300 according to an aspect of the disclosure.

The controller 300 generates a practice travelling route, and executes a practice travelling mode at 3401.

The controller 300 may determine the number of occupants in the vehicle 1 based on the detection result of the sensor 100 at 3402. In this case, a camera, a pressure sensor, or a temperature sensor included in the sensor 100 may be used. However, the sensor included in the sensor 100 is not limited thereto, and may further include a sensor capable of determining the number of occupants present in the vehicle 1.

When it is determined that two or more occupants exist in the vehicle 1, the controller 300 ends the practice travelling mode at 3403. However, when it is determined that there are less than two (2) occupants in the vehicle 1, the controller 300 continues to execute the practice travelling mode.

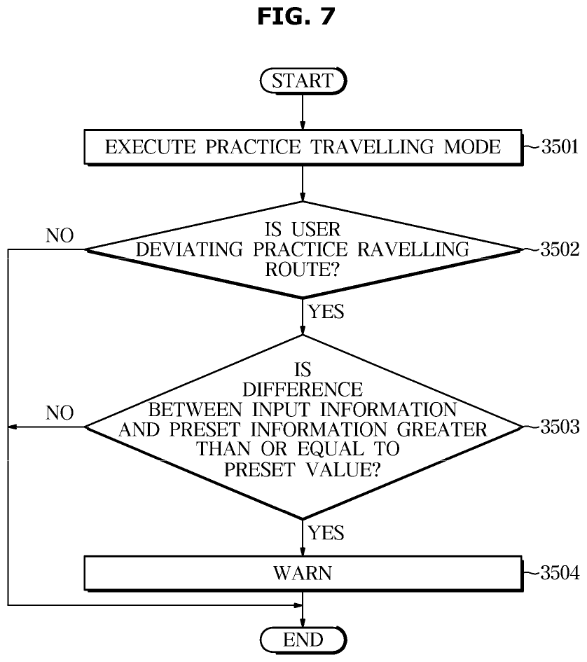

FIG. 7 illustrates a process of the controller 300 warning a user via a warner 500 according to an aspect of the disclosure.

When the practice travelling mode of the vehicle 1 is executed, the controller 300 may determine whether the user has deviated from the practice travelling route at 3501 and 3502.

When it is determined that the user has deviated from the practice travelling route, the controller 300 determines whether the difference between information input while the vehicle 1 is deviating from the practice travelling route and preset information is greater than or equal to a preset value at 3503.

Here, the information input while the vehicle 1 is deviating from the practice travelling route and the preset information may represent information used for the controller 300 to determine whether the user is a novice driver. However, the information input while the vehicle 1 is deviating from the practice travelling route is not limited thereto, and may further include other factors affecting the travelling of the vehicle 1.

In addition, the preset value may represent a criterion for the controller 300 to determine whether the user is a novice driver. However, the preset value is not limited thereto, and may be changed according to a user definition.

When it is determined that the difference between the information input while the vehicle 1 is deviating from the practice travelling route and the preset information is greater than or equal to the preset value, the controller 300 may warn the user via the warner 500 at 3504.

In detail, the warning method of the warner 500 may employ a method of informing a user of a departure of a travelling route through a head-up display (HUD), a method of generating sound through an audio system provided in the vehicle 1, a method of alarming a driver by generating vibration on a steering wheel upon determining a lack or insufficiency of steering control, or a method of warning a driver by generating vibration on an accelerator pedal to be transmitted to the driver. However, the warning method is not limited thereto, and may further include another method for informing the user of the departure of the travelling route.

As is apparent from the above, the embodiment can determine whether a user is a novice driver without analyzing a travelling pattern of the user, and provide a user with a travelling practice guide based on the determination result.

In addition, the vehicle and the method of controlling the same according to the embodiment can perform a vehicle pilot driving based on the provided travelling practice guide.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random-Access Memory (RAM), a magnetic tape, a magnetic disk, a flash memory, an optical data storage device, and the like.

Although exemplary embodiments of the present disclosure have been described for illustrative purposes, those skilled in the art will appreciate that various modifications, additions and substitutions are possible, without departing from the scope and spirit of the disclosure. Therefore, exemplary embodiments of the present disclosure have not been described for limiting purposes.

1. A vehicle comprising:
a sensor configured to detect a travelling environment of the vehicle;
an inputter configured to receive acceleration or deceleration information, steering information, or braking information during travel of the vehicle; and
a controller configured to compare the information received by the inputter with preset information, determine whether a user is a novice driver based on a result of the comparison, and control at least one of a driving device, a steering device, or a braking device provided in the vehicle based on a result of the determination.

2. The vehicle of claim 1, further comprising a display on which a traveling route of the vehicle is displayed, wherein the controller generates a practice travelling route and controls the display to display the generated practice travelling route.

3. The vehicle of claim 2, wherein the controller determines whether a frequent accident area or a construction section exists in the practice travelling route, and ends a driving practice mode when the frequent accident area or the construction section exists in the practice travelling route.

4. The vehicle of claim 2, wherein the controller determines a degree of difficulty of the practice travelling route, and causes a display to display a result of the determination.

5. The vehicle of claim 1, wherein the controller determines a type of a road being travelled by the vehicle, and executes a practice travelling mode according to a city travelling practice mode, a parking practice mode, or a highway travelling practice mode based on a result of the determination.

6. The vehicle of claim 5, further comprising a communicator configured to receive information related to a destination from a user terminal, wherein the controller generates a practice travelling route to the destination, determines a type of a road included in the generated practice travelling route, and executes the practice travelling mode according to the city travelling practice mode, the parking practice mode, or the highway travelling practice mode based on a result of the determination.

7. The vehicle of claim 1, further comprising an occupant detecting sensor configured to detect a number of occupants boarding the vehicle, wherein the controller ends the driving practice mode upon determining that the number of the occupants boarding the vehicle is two or more as a result of the detection by the sensor.

8. The vehicle of claim 1, wherein the controller determines whether the user is a novice driver upon determining that a result of the detection by the sensor is a rainfall or snowfall situation and an off-state of a wiper.

9. The vehicle of claim 1, further comprising a warner configured to warn the user via sound or vibration, wherein the controller compares the information received by the inputter with preset information, and controls the warner upon determining that a result of the comparison is greater than or equal to a predetermined value.

10. The vehicle of claim 1, wherein the controller allows the vehicle to perform a pilot travelling based on the received information.

11. A method of controlling a vehicle, the method comprising:
detecting a travelling environment of the vehicle at a controller;
receiving acceleration or deceleration information, steering information, or braking information during travel of the vehicle; and
comparing the receive information with preset information, determining whether a user is a novice driver based on a result of the comparison, and controlling at least one of a driving device, a steering device, or a braking device provided in the vehicle based on a result of the determination.

12. The method of claim 11, further comprising controlling a display to display a traveling route of the vehicle, and generating a practice travelling route and controlling the generated practice travelling route to be displayed.

13. The method of claim 12, further comprising determining whether a frequent accident area or a construction section exists in the practice travelling route, and ending a driving practice mode when the frequent accident area or the construction section exists in the practice travelling route.

14. The method of claim 12, further comprising determining a degree of difficulty of the practice travelling route, and controlling a result of the determination to be displayed.

15. The method of claim 11, further comprising determining a type of a road being travelled by the vehicle, and executing a practice travelling mode according to a city travelling practice mode, a parking practice mode, or a highway travelling practice mode based on a result of the determination.

16. The method of claim 15, further comprising receiving information related to a destination from a user terminal, and generating a practice travelling route to the destination, determining a type of a road included in the generated practice travelling route, and executing the practice travelling mode according to the city travelling practice mode, the parking practice mode, or the highway travelling practice mode based on a result of the determination.

17. The method of claim 11, further comprising detecting a number of occupants boarding the vehicle, and ending the driving practice mode upon determining that the number of the occupants boarding the vehicle is two or more as a result of the detection.

18. The method of claim 11, further comprising determining whether the user is a novice driver upon determining that a result of the detection is a rainfall or snowfall situation and an off-state of a wiper.

19. The method of claim 11, further comprising warning the user through sound or vibration, and comparing the received information with preset information, and warning upon determining that a result of the comparison is greater than or equal to a predetermined value.

20. The method of claim 11, further comprising allowing the vehicle to perform a pilot travel based on the received information.
